(19) United States
(12) Patent Application Publication
(10) Pub. No.: US 2016/0343213 A1
(43) Pub. Date: Nov. 24, 2016

(54) SECURE CARD CASSETTE

(71) Applicant: ASAHI SEIKO CO., LTD., Tokyo (JP)

(72) Inventors: Alex MASSEY, Kent (GB); Marcus John WILLIS, Kent (GB)

(73) Assignee: ASAHI SEIKO CO., LTD., Tokyo (JP)

(21) Appl. No.: 15/155,487

(22) Filed: May 16, 2016

(30) Foreign Application Priority Data
May 22, 2015 (GB) GB1508830.5

(51) Int. Cl. G07F 17/42; G07F 11/44; B65H 43/00; G07F 11/00

(52) U.S. Cl. CPC G07F 17/42; G07F 11/002; G07F 11/44; B65H 43/00; B65H 2402/443

(57) ABSTRACT

A system for dispensing cards is provided comprising a card cassette configured to store a stack of cards and a card dispenser configured to dispense cards from the card cassette. The card cassette comprises a shutter configured to move from a closed position to an open position so as to enable the dispenser to receive a card from the stack. The card cassette also comprises a cassette controller configured to enable movement of the shutter. During an initialisation process, the cassette controller is configured to analyse an authentication signal output by the dispenser and enable movement of said shutter based on said analysis.

The present invention relates to a secure cassette for storage and transportation of a stack of cards to be dispensed by a dispenser.

Card dispensers are widely known and are often incorporated into ticket vending machines, such as those often found at public transport stations. A card containing certain amount of pre-paid credit may be dispensed by dispenser in response to a purchase made at the vending machine. Each card may typically contain a secure element, such as a magnetic strip, or an integrated circuit “IC” chip, which is able to store data. Data encryption onto the card may occur at the dispenser itself, or before the card is loaded onto the dispenser.

Cards are typically provided to a dispenser in a cassette, which is a separable unit from the dispenser that may be removed and replaced by a technician when the dispenser has run out of cards, or when different card types are required. The cards are typically stacked on top of one another within the cassette so as to form a vertically aligned stack of cards, housed inside the container. The lowermost card from the stack is typically retrievable by the dispenser during use.

A door on the cassette may be opened in order to load cards into the cassette and closed to secure these cards. As each card may have monetary value to it, it is desirable to make the cassette secure such that cards are not easily stolen from the cassette either during transportation of the cassette, or whilst it is fitted to the dispenser. The cassette door is therefore typically lockable, requiring a bespoke key in order to be opened. A shutter may be provided at the base of the cassette to allow access to only the lowermost card from the stack. This shutter may also be lockable such that a key is required to open the shutter. Further protection may be afforded by providing a shutter controller that is configured to engage with the lock system so as to prevent the shutter from opening when the cassette is separated from a dispenser, or if the cassette has not been correctly installed. The lock system may also include or alternatively be a solenoid lock which is operable to engage with the shutter to prevent the shutter from opening. When the cassette is inserted into a dispenser, an electronic circuit may be completed on the cassette causing the lock system to disengage from the shutter, thereby allowing the shutter to be manually opened. Electronic circuits such as these are easily completed using counterfeit devices or measures however without the appropriate dispenser being required. It is therefore desirable to further increase the security of card cassettes so as to prevent unauthorised access to the cards contained therein.

In accordance with a first aspect of the invention, there is provided a system for dispensing cards comprising:
a card cassette configured to store a stack of cards; and
a card dispenser configured to dispense cards from the card cassette;
wherein the card cassette comprises a shutter configured to move from a closed position to an open position so as to enable the dispenser to receive a card from the stack;
wherein the card cassette comprises a cassette controller configured to enable movement of the shutter; and
wherein, during an initialisation process, the cassette controller is configured to analyse an authentication signal output by the dispenser and enable movement of said shutter based on said analysis.

The above system provides an enhanced level of security by requiring a degree of intelligence to be present on the card cassette. The card cassette is now required to comprise a cassette controller, which is an electronic controller, and is able to analyse an authentication signal provided by the dispenser to determine whether or not to allow movement of the shutter. The cassette controller may thus require a specific authentication signal (or authentication signals) in order to ‘unlock’ or open the shutter. If this signal is provided, the initialisation process will successfully complete. The authentication signal may comprise a specific series of pulses and is typically harder for thieves to replicate in order to gain unauthorised access to cards from the cassette, than simply completing an electronic circuit on the cassette, as occurs in some known systems. The cassette controller may thus comprise one or more processors, memory (both volatile and non-volatile) and potentially an on-board power source (such as a battery) in order to carry out the signal analysis.

A variety of different levels of security may be enabled by the above system. For example, in a basic approach, one-way communication from the dispenser to the cassette controller occurs during the initialisation process. The cassette controller may simply receive an authentication signal from the dispenser, analyse it and then enable movement of the shutter if the signal is determined to be “correct”. Said analysis may involve comparing the authentication signal to one or more pre-determined signals stored in memory on the cassette controller to see if the signal can be recognised. In a more advanced embodiment, two-way data exchange occurs between the cassette controller and the dispenser during the initialisation process. This may involve a “hand-shaking” procedure wherein the cassette controller and the dispenser communicate back and forth with each other. Said two-way data exchange typically comprises a security authentication procedure. A second electronic controller, this time located on the dispenser (and referred to herein as the dispenser controller) may be required to carry out this two-way data exchange as certain set responses may be required from either the dispenser or the cassette in response to certain incoming signals. The security authentication procedure could require a pre-determined password on the card cassette or dispenser to be provided by the other device, and could be further enhanced by the use of rolling codes. In the basic one-way communication approach a dispenser controller is not required however as the dispenser could continually output an authentication signal, with no degree of intelligence being required on the dispenser to process incoming data signals from the card cassette.

In the two-way communication approach the authentication signal may comprise either all, or part, of the signals sent from the dispenser controller to the cassette controller during said process. Indeed it may further comprise all or part of the signals sent from the cassette controller to the dispenser controller during the initialisation process. Typically however the authentication signal is the final signal output from the dispenser to the cassette controller during the initialisation process.

Additional security can be provided wherein the cassette controller is electrically connected to the dispenser by a serial connection. This may require the cassette and the dispenser to each comprise serial interface connectors. For example, bespoke male or female electrical terminals may be provided on the card cassette and the dispenser to enable a physical electrical connection between the two units when the card cassette is installed to the dispenser. This serial connection would be again harder to replicate in order to open the card cassette when separated from the dispenser.

In some applications, it is known to provide cassettes with on-board memory that may store a Unique Identification Number (UID) for the cassette and potentially information regarding the number or type of articles stored in the cassette. This is conventionally provided for tracking and traceability purposes. The data may be accessed by technicians when filling the cassettes, or may be accessed by a host server connected to the dispenser to monitor the position and stock level in various cassettes across a network of dispensers. In the present application however further security may be achieved by using this information as part of the initialisation process. For example, said cassette controller may comprise memory containing data relating to identity of the card cassette and the identity of one or more dispensers with which the card cassette is intended for use. Said identities may then be compared during the initialisation process. This comparison may be performed by the cassette controller and/or the dispenser controller. If for example the dispenser controller performs this comparison, it may subsequently issue an authentication signal to the cassette controller indicating, for example, whether or not the dispenser and the cassette are compatible together. If the cassette controller performs the comparison, the signal issued by the dispenser to the cassette which includes the dispenser identity data to it could be considered the authentication signal (or at least part of this authentication signal). Preferably said comparison is performed by the cassette controller. The cassette controller can thus be programmed such that it can only be opened at one or more specific dispensers. A successful initialisation process could also, or alternatively, be contingent on data stored on the dispenser pertaining to the dispenser location.

Security may be further enhanced wherein the dispenser is connected to a host server via a network, and wherein control of the authentication signal sent by the dispenser is determined by the host server. For example, the host server may be configured to monitor the UIDs from card cassettes installed into a plurality of card dispensers across a network. The cassette may hence be made further secure by requiring a ‘live’ key to be issued by the host server in order to be able to raise the shutter. In the event that a duplicate card cassette UID is detected, the host server may prevent the dispenser from outputting the appropriate authentication signal to complete the initialisation process. An alarm may instead be raised to indicate that some level of fraud may have occurred. The host server also allows a greater degree of flexibility to manage a plurality of card dispensers across a network, so as to make real time changes to the types of card cassettes with which these dispensers may receive cards from.

The cassette controller may itself be configured to control movement of said shutter. For example, the cassette controller may be configured to move the shutter based on the analysis of the authentication signal. If the initialisation process is successful (i.e. the “correct” authentication signal for opening the shutter is monitored by the cassette controller) the cassette controller may output an electrical signal, for example to a shutter drive means, causing the shutter to open automatically. This shutter drive means may include a motor, and potentially a pulley system, for moving the shutter from a closed configuration to an open configuration in response to the electrical output from the cassette controller. In an advantageous arrangement however the card cassette further comprises a shutter controller configured to open and close the shutter in response to a mechanical input provided by a user. A lock system may then be provided to allow or prevent movement of the shutter controller in response to an electronic signal provided by the cassette controller based on the initialisation process (i.e. based on the analysis of the authentication signal). Most preferably, the shutter controller includes a manually operable lock member (for example requiring a bespoke key for operation). The lock system also preferable includes a solenoid lock operable to engage with the shutter controller to prevent operation of said shutter controller. Alternatively, or in addition to this, the lock system may include a solenoid lock operable to engage with the shutter to prevent opening of the shutter, This may be the same, or a different solenoid lock from the solenoid lock previously referred to that engages with the shutter controller. The lock system may comprise a retractable member that is driven, for example, by an electromagnet so as to engage or disengage with the shutter in accordance with the output from the cassette controller. Motion may then be transferred from the shutter controller to the shutter by a mechanical connection. The shutter controller may require a physical actuation, e.g. by a rotating key, in order to raise the shutter, thus providing added security to the cassette. This system is also less prone to mechanical failure than motorised belts, for example.

In accordance with a second aspect of the invention there is provided a card cassette for use in accordance with the first aspect of the invention. The second aspect shares the same advantages and similar features as already discussed with reference to the first aspect.

Examples of the invention will now be discussed with reference to the accompanying drawings, in which:—

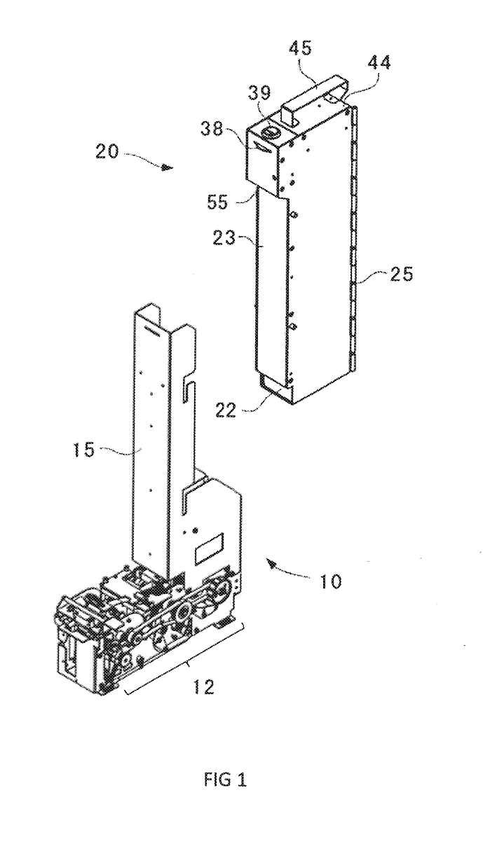

FIG. 1 is an illustration of an example of a system comprising a card cassette and a dispenser according to the invention: and

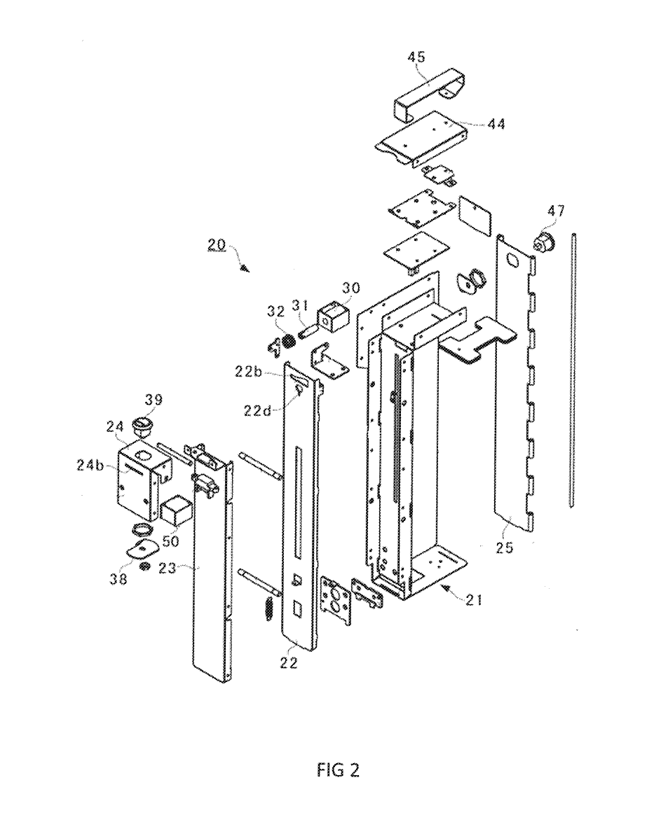

FIG. 2 is an illustration of an exploded view of components of an example of a card cassette according to the invention.

A card cassette 20 and a corresponding card dispenser 10 are shown separately in FIG. 1. Components of the card cassette 20 only are shown in FIG. 2. The cassette 20 forms a housing that is configured to store a plurality of cards provided as a vertically aligned stack. These cards can in principle be any size, but are typically of the standardised ID-1 format (85.60×53.98 mm) and typically contain a secure element for storing data. Data encryption onto the secure elements may occur via conventional contact or contactless means either at the dispenser 10 or before the cards are loaded into the card cassette 20. The stack may be loaded inside the cassette 20 by opening a door 25, provided on the rear surface of the cassette, and which pivots on a hinge that is aligned with the vertical axis of the cassette 20. This door 25 may be locked in its closed configuration using a door lock 47 so as to secure the cards within the cassette 20.

A shutter 22 is provided at the front of the cassette 20 to allow access to an end card from the stack contained therein. In this case the end card is the lowermost card in the stack. The shutter 22 is essentially a vertically moveable plate, located behind a front plate 23 and appears as a window that may be retracted upwards in order to open the cassette 20 or closed downwards in order to close the cassette 20. Opening the shutter exposes the lowermost card from the stack.

The cassette 20 has a top surface 44 onto which a handle 45 is attached for ease of transportation when carrying the cassette 20. A mechanical shutter controller 39 in the form of a lock is also provided on the top surface 44. The shutter controller 39 is configured to move from a locked configuration, wherein the shutter 22 is closed, to an unlocked configuration, wherein the shutter is opened, in response to a user inserting and turning a bespoke key inside the lock 39. Rotation of the shutter controller 39 causes a cam 38 to rotate inside a grooved aperture 22b provided on the shutter 22. As the cam is rotated against the groove 22b, it acts against the groove so as to exert an upward force onto the shutter 22. In alternative examples, no shutter controller 39 is provided as the shutter 22 itself may be moved automatically by shutter drive means comprising motorised belts, in response to electrical signals sent by a cassette controller 50 following an initialisation process (to be described).

A third lock, referred to as the lock system (or the “solenoid lock”) 30, is also provided. No manual input or physical key is required to operate this lock. The lock system 30 comprises a retractable member 31 provided within a solenoid 32. The retractable member 31 is driven by an electromagnetic force induced by a solenoid 32 and is configured to engage with a shutter plate aperture 22d provided on the shutter 22 so as to prevent vertical motion of the shutter 22. The lock system 30 is configured such that the retractable member 31 will by default engage with the shutter plate aperture 22d, unless an electrical signal is provided to the lock system 30 by the cassette controller 50 as a result of a successful initialisation process. If the retractable member 31 is retracted (i.e. not engaged) with the shutter plate aperture 22d, the shutter controller 39 and cam 38 are able to rotate. Rotation of the cam 38 inside the groove aperture 22b causes the shutter 22 to lift, thereby exposing the lowermost card from the stack to the dispenser 10. Turning the shutter controller 39 may also move a number of mechanical engagement features on the cassette 20 so as to secure the cassette 20 to the dispenser 10. In this case, rotation of cam 38 inside slot 24b physically exposes a part of the cam 38 which engages with a corresponding slot (not shown) in the dispenser 10 so as to physically lock the cassette 20 to the dispenser 10. In alternative systems, the shutter controller 39 may be actuated without the use of a key, for example by instead turning a handle.

The cassette 20 is provided with an electronic cassette controller 50 comprising a printed circuit board (PCB), processor and memory (both volatile and non-volatile) for storing information regarding the cassette 20 and for communicating with a card dispenser 10. Information stored by the cassette controller 50 may include a unique identification number (UID) assigned to the cassette 20, the number and/or type of cards contained within the cassette 20 and the dispenser number or location which the cassette 20 is intended to be fitted to. An on-board power source may be provided to the cassette controller 50 in the form of a battery located on the cassette 20. Alternatively, electrical power may be supplied to the cassette 20 by the dispenser 10. Additional electronic components may also be provided on the cassette 20. For example a transceiver may be provided for transmitting the GPS co-ordinates of the cassette 20 or status updates to a server. The cassette 20 may also include sensors to detect the number of cards stored within the cassette 20 and/or possible tampering or unauthorised access to the cassette 20. The cassette 20 may even include an alarm system that will activate if unauthorised access is detected.

The card cassette 20 is configured to mate with and be secured to the dispenser 10. In this case the front surface 23 of the cassette 20 abuts onto a receiving plate 15 on the dispenser 10 and the cassette 20 is slotted downwards until the base 21 of the cassette 20 abuts onto a top surface of the dispenser 10. This physical connection also connects a serial interface wherein a male or female serial port connector 55 provided on the cassette 20 engages with a corresponding female or male serial port connector on the dispenser 10. This electrical connection enables data transfer to occur between the dispenser 10 and the card cassette 20 during an initialisation process. Alternatively, said electronic communication may occur wirelessly, with appropriate transmitters and receivers being fitted to the cassette 20 and dispenser 10, or by connecting appropriate wires between the dispenser 10 and the cassette 20.

The dispenser 10 comprises a drive mechanism 12 which is configured to extract and convey a lowermost card from the card cassette 20 when the shutter 22 is open. Alternatively, the cassette 20 itself may comprise its own drive mechanism (not shown) so as to convey an end card from the cassette to the dispenser 10 when the shutter 22 is open. The card may then be conveyed through a card communication module (wherein data may be encrypted and verified) to a dispense position (such as a bezel located at the front of a ticket vending machine into which the dispenser 10 is incorporated). The dispenser 10 also comprises a computer (not shown) which may store information regarding the dispenser 10 (such as its UID and location), control motion of the drive mechanism 12 and a user interface configured to process purchases that are made by customers. This computer may be connected to a host server via a network, such as the Internet.

Various examples of initialisation processes will now be described. In a basic embodiment the dispenser 10 will continually output an electrical authentication signal at a characteristic frequency for the dispenser 10. This signal may be generic to all card dispensers of a given make/model, or may be unique to the individual dispenser 10. If the dispenser 10 and the cassette 20 are electrically connected to one another, the cassette controller 50 will detect this signal and analyse it to check whether it corresponds to one or more “correct” authentication signals stored in memory. If the signals match, the cassette controller 50 will determine that the initialisation process is a success (i.e. that the card cassette 20 is connected to an appropriate card dispenser 10). An electrical signal will then be output from the cassette controller 50 to the solenoid 30 causing the retractable member 31 to disengage from the shutter plate aperture 22d, allowing the shutter controller 39 to be rotated by a user to open the shutter 22. If the authentication signal is not recognised by the cassette controller 50, the lock system 30 may remain engaged with the shutter 22, thereby preventing the shutter 22 from opening. In alternative examples, the lock system 30 may instead be operable to engage with and disengage from the shutter controller 39 (rather than the aperture 22d in the shutter 22) to prevent or allow the shutter 22 from opening.

In a second embodiment two way communication occurs between a dispenser controller and the cassette controller 50 during the initialisation process. Data is transmitted as characters, wherein each character is an 8 bit byte. Each bit is binary; wherein a “0” is sent as a 10 microsecond high amplitude electrical signal followed by a 20 microsecond low amplitude signal and a “1” signal is sent as a 20 microsecond high signal followed by a 10 microsecond low signal.

Once the cassette 20 is electrically connected to the dispenser 10, the two units will begin exchanging data. In this example the dispenser 10 is in control of requesting and obtaining responses from the cassette 20 during this data exchange (however the reverse is also possible). The dispenser controller will output a command formed of a series of characters to the cassette controller 50. The dispenser controller and the cassette controller 50 each have one or more commands and pre-defined responses stored in memory which form a security authentication procedure. For example, the dispenser may initially send a request for a simple response from the cassette controller 50. When a command has completed, the dispenser controller will output a high signal and wait a predetermined amount of time for the cassette controller 50 to process the data before outputting a sustained low signal (for more than 10 microseconds).

The data output from the dispenser 10 is released to a high impedance state (typically a Tri-State). When the cassette controller 50 detects the low state of the data line, it will set the data line to either a high or low state corresponding to the state of the bit it wishes to send. After an additional 5 microseconds the dispenser controller will check the data line state and read it as a ‘1’ or a ‘0’. It will wait a further 10 microseconds before repeating this process a total of 8 times. Once complete, the dispenser controller will have received one complete byte from the cassette controller 50. The dispenser controller will then continue normal operation until the next timer interrupt occurs where upon it will repeat the process for the next byte. This will continue to repeat until an ETX character is received, at which point all data has been received.

The first response from the cassette controller 50 may be a command requesting the dispenser controller to output its UID back to the cassette controller 50. The dispenser controller will receive this command, retrieve its UID from its memory and respond to the cassette controller 50 with an authentication signal comprising this information, The cassette controller 50 will then analyse the dispenser UID and compare it to one or more dispenser UIDs stored on the cassette memory (for which the cassette 20 is approved for use with). If the UID is recognised by the cassette controller 50 and approved, the initialisation process will be deemed successful and the shutter 22 may be opened. If the UID is not recognised, or an inappropriate (or no) response is detected by the cassette controller 50, the initialisation process will fail and the shutter 22 will remain locked in its closed configuration. The ultimate control over whether or not the shutter 22 may be opened is thus determined by the cassette controller 50 processing one or more authentication signals provided by the dispenser 10.

In alternative embodiments, information such as the intended dispenser location for the cassette 20 and the actual dispenser location may also be retrieved and compared during the initialisation process. This information may also form part of the authentication signals provided by the dispenser 10. Furthermore, the security authentication procedure could be enhanced still through the use of passwords, such as rolling keys, provided on either or both devices. In yet a further embodiment, the dispenser controller may communicate with a host server during the initialisation process via the Internet and the authentication signal(s) provided by the dispenser 10 may depend on the response given by the host server. The cassette controller 50 may also report any information detected by sensors on the cassette 20 (e.g. relating to tampering of the cassette 20 or the number of cards contained therein) and/or data programmed onto the cassette 20 by a technician, to the dispenser 10, and potentially onto a host server as part of the initialisation process, or subsequent to this.

As will be appreciated from the above, an improved system is provided to increase the security of card cassettes by building in a degree of intelligence to the cassette itself. This system can advantageously be retrofitted to existing card dispensers and card cassettes.

1. A system for dispensing cards comprising:
a card cassette configured to store a stack of cards; and
a card dispenser configured to dispense cards from the card cassette;
wherein the card cassette comprises a shutter configured to move from a closed position to an open position so as to enable the dispenser to receive a card from the stack;
wherein the card cassette comprises a cassette controller configured to enable movement of the shutter; and
wherein, during an initialisation process, the cassette controller is configured to analyse an authentication signal output by the dispenser and enable movement of said shutter based on said analysis.

2. A system according to claim 1, wherein two-way data exchange occurs between the cassette controller and the dispenser during the initialisation process.

3. A system according to claim 2, wherein said two-way data exchange comprises a security authentication procedure.

4. A system according to claim 1, wherein the cassette controller is electrically connected to the dispenser by a serial connection.

5. A system according to claim 1, wherein said cassette controller comprises memory containing data relating to identity of the card cassette and the identity of one or more dispensers with which the card cassette is intended for use; and wherein said identities are compared during the initialisation process.

6. A system according to claim 5, wherein said comparison is performed by the cassette controller.

7. A system according to claim 1, the dispenser is connected to a host server via a network, and wherein control of the authentication signal sent by the dispenser is determined by the host server.

8. A system according to claim 1, wherein the cassette controller is configured to move the shutter based on the analysis of the authentication signal.

9. A system according to claim 1, wherein the card cassette further comprises:
a shutter controller configured to open and close the shutter in response to a mechanical input provided by a user; and
a lock system configured to allow or prevent movement of the shutter controller in response to an electronic signal provided by the cassette controller based on the initialisation process.

10. A system according to claim 9, wherein the shutter controller includes a manually operable lock member.

11. A system according to claim 10, wherein the lock system includes a solenoid lock operable to engage with the shutter controller to prevent operation of said shutter controller.

12. A system according to claim 9, wherein the lock system includes a solenoid lock operable to engage with the shutter to prevent opening of the shutter.

13. A card cassette for use in a system according to claim 1 comprising:
a shutter configured to move from a closed position to an open position so as to enable the dispenser to receive a card from the stack; and
a cassette controller configured to enable movement of the shutter;
wherein, during an initialisation process, the cassette controller is configured to analyse an authentication signal output by a dispenser and enable movement of said shutter based on said analysis.

14. A card cassette according to claim 13, wherein the cassette controller is configured to move the shutter based on the analysis of the authentication signal.

15. A card cassette according to claim 13, further comprising:
a shutter controller configured to open and close the shutter in response to a mechanical input provided by a user; and
a lock system configured to allow or prevent movement of the shutter controller in response to an electronic signal provided by the cassette controller based on the initialisation process.

16. A card cassette according to claims 15, wherein the shutter controller includes a manually operable lock member.

17. A card cassette according to claim 15, wherein the lock system includes a solenoid lock operable to engage with the shutter controller to prevent operation of said shutter controller.

18. A card cassette according to claim 15, wherein the lock system includes a solenoid lock operable to engage with the shutter to prevent opening of the shutter.
